(19) United States
(12) Patent Application Publication
(10) Pub. No.: US 2013/0126055 A1
(43) Pub. Date: May 23, 2013

(54) ALUMINUM ALLOY CONDUCTOR AND METHOD OF PRODUCING THE SAME

(71) Applicants: FURUKAWA ELECTRIC CO., LTD., Tokyo (JP); FURUKAWA AUTOMOTIVE SYSTEMS INC., Inukami-gun (JP)

(72) Inventors: Shigeki SEKIYA, Tokyo (JP); Kyota SUSAI, Tokyo (JP); Kuniteru MIHARA, Tokyo (JP)

(73) Assignees: FURUKAWA AUTOMOTIVE SYSTEMS INC., Inukami-gun (JP); FURUKAWA ELECTRIC CO., LTD., Tokyo (JP)

(21) Appl. No.: 13/744,107

(22) Filed: Jan. 17, 2013

Related U.S. Application Data
(63) Continuation of application No. PCT/JP2011/066259, filed on Jul. 15, 2011.

(30) Foreign Application Priority Data
Jul. 20, 2010 (JP) 2010-163415

(51) Int. Cl. H01B 1/02; H01B 13/00

(52) U.S. Cl. CPC H01B 1/023; H01B 13/0016; H01B 13/0006
USPC 148/550; 148/439

(57) ABSTRACT

An aluminum alloy conductor, having a specific aluminum alloy composition of Al—Fe—Cu—Mg—Si—(TiN) or Al—Fe—(Cu/Mg/Si)—(TiN), in which, on a cross-section vertical to a wire-drawing direction, a grain size is 1 to 20 μm, and a distribution density of a second phase with a size of 10 to 200 nm is 1 to 10² particles/μm²; and a production method thereof.

### TECHNICAL FIELD

The present invention relates to an aluminum alloy conductor that is used as a conductor of an electrical wiring, and a method of producing the same.

### BACKGROUND ART

Hitherto, a member in which a terminal (connector) made of copper or a copper alloy (for example, brass) is attached to electrical wires comprised of conductors of copper or a copper alloy, which is called a wire harness, has been used as an electrical wiring for movable bodies, such as automobiles, trains, and aircrafts. In weight reduction of movable bodies in recent years, studies have been progressing on use of aluminum or an aluminum alloy that is lighter than copper or a copper alloy, as a conductor for the electrical wiring.

The specific gravity of aluminum is about one-third of that of copper, and the electrical conductivity of aluminum is about two-thirds of that of copper (when pure copper is considered as a criterion of 100% IACS, pure aluminum has about 66% IACS). Therefore, in order to pass an electrical current through a conductor wire of pure aluminum, in which the intensity of the current is identical to that through a conductor wire of pure copper, it is necessary to adjust the cross-sectional area of the conductor wire of pure aluminum to about 1.5 times larger than that of the conductor wire of pure copper, but aluminum conductor wire is still more advantageous in mass than copper conductor wire in that the former has an about half weight of the latter.

Herein, the term “% IACS” mentioned above represents an electrical conductivity when the resistivity 1.7241×10⁻⁸ Ωm of International Annealed Copper Standard is defined as 100% IACS.

There are some problems in using the aluminum as a conductor of an electrical wiring for movable bodies. One of the problems is improvement in resistance to bending fatigue. This is because a repeated bending stress is applied to a wire harness attached to a door or the like, due to opening and closing of the door. A metal material, such as aluminum, is broken at a certain number of times of repeating of applying a load when the load is applied to or removed repeatedly as in opening and closing of a door, even at a low load at which the material is not broken by one time of applying the load thereto (fatigue breakage). When the aluminum conductor is used in an opening and closing part, if the conductor is poor in resistance to bending fatigue, it is concerned that the conductor is broken in the use thereof, to result in a problem of lack of durability and reliability.

In general, it is considered that as a material is higher in mechanical strength, it is better in fatigue property. Thus, it is preferable to use an aluminum wire high in mechanical strength. On the other hand, since a wire harness is required to be readily in wire-running (i.e. an operation of attaching of it to a vehicle body) in the installation thereof, an annealed material is generally used in many cases, by which 10% or more of elongation can be ensured.

A second problem is improvement in resistance to stress relaxation. Generally, in metal materials, stress relaxation phenomenon may occur, in which the stress acting on the material is lowered. In a connection unit between an aluminum conductor and a terminal, when the stress relaxation phenomenon occurs in the aluminum conductor, the contact pressure at the connection unit is lowered, and thus electric connection cannot be secured. The stress relaxation phenomenon is more apt to occur at a higher temperature. When an automobile is taken as an example of movable bodies, the temperature of the cabin area where people ride or baggage is placed is about 80° C., and the temperature of the engine room or an area for the driving motor reaches about 120° C. locally when heat generation therefrom is taken into account. Thus, those areas give a use environment, in which the stress relaxation phenomenon is apt to occur, which poses a very serious problem.

A third problem is improvement in workability. Wires of copper or aluminum are produced by various methods. In general, a wire is obtained by plastic working a casting of copper or aluminum, and the wire is required to have an excellent workability that does not cause any problem, such as wire breakage in the plastic working. When an aluminum conductor is poor in workability, wire breakage occurs in the plastic working, and the productivity of the conductor cannot be improved. In addition to that, when such an aluminum conductor is used as an electrical wiring, there is a concern of breakage of the conductor, which arises a problem of the lack of durability and reliability.

Under the above situations, as an aluminum conductor that is used in an electrical wiring of a movable body, a material is demanded, which is excellent in mechanical strength and flexibility, which are required in handling of it and attaching it to an object, and which is excellent in electrical conductivity that is required for passing much electricity, as well as which is excellent in resistance to bending fatigue, resistance to stress relaxation, and workability.

With respect to applications for which such a demand is exist, ones of pure aluminum-systems represented by aluminum alloy wires for electrical power lines (JIS A1060 and JIS A1070), cannot sufficiently satisfy the required properties. Further, although an alloy in which various additive elements are added is excellent in mechanical strength, the alloy has such problems, in some cases, that the electrical conductivity is lowered due to solid-solution phenomenon of the additive elements in aluminum, and that wire breakage may occur in wire-drawing due to formation of excess intermetallic compounds in aluminum. Therefore, it is necessary to limit and select additive elements, to prevent breakage as an essential feature, to prevent lowering in electrical conductivity, and to enhance mechanical strength and resistance to bending fatigue, as well as resistance to stress relaxation.

Typical aluminum conductors used in electrical wirings of movable bodies include those described in Patent Literatures 1 to 3. However, the electrical wire conductor described in Patent Literature 1 is too high in tensile strength, and thus an operation of attaching it to a vehicle body may become difficult in some cases. The aluminum conductive wire that is specifically described in Patent Literature 2 has not undergone any finish annealing. An aluminum conductive wire having higher flexibility is required for an operation of attaching it to a vehicle body. Patent Literature 3 discloses an aluminum conductive wire that is light, flexible and excellent in resistance to bending property, but there is a demand on further improvement of the properties. In the alloy of the invention described in Patent Literature 3, Si is an unavoidable impurity, and is not an alloy element that is added positively.

### CITATION LIST

Patent Literatures
Patent Literature 1: JP-A-2008-112620 (“JP-A” means unexamined published Japanese patent application)
Patent Literature 2: JP-A-2006-19163
Patent Literature 3: JP-A-2006-253109

### SUMMARY OF INVENTION

### Technical Problem

The present invention is contemplated for providing an aluminum alloy conductor, which has sufficient tensile strength, flexibility, and electrical conductivity, which exhibits high resistance to bending fatigue and resistance to stress relaxation, and which is excellent in workability.

### Solution to Problem

The inventors of the present invention, having studied keenly, found that an aluminum alloy conductor can be produced, which exhibits high resistance to bending fatigue and resistance to stress relaxation, which is excellent in workability, and which has sufficient mechanical strength, flexibility, and electrical conductivity, by controlling the composition of the aluminum alloy and the production conditions, to control a grain size and a dispersion density of a second phase. The present invention is attained based on that finding.

That is, according to the present invention, there is provided the following means:

(1) An aluminum alloy conductor, containing: 0.01 to 0.4 mass % of Fe, 0.1 to 0.5 mass % of Cu, 0.04 to 0.3 mass % of Mg, and 0.02 to 0.3 mass % of Si, and further containing 0.001 to 0.01 mass % in total of Ti and V, with the balance being Al and inevitable impurities,
wherein, on a cross-section vertical to a wire-drawing direction, a grain size is 1 to 20 μm, and a distribution density of a second phase with a size of 10 to 200 nm is 1 to 10² particles/μm².
(2) An aluminum alloy conductor, containing: 0.4 to 1.2 mass % of Fe, and 0.02 to 0.5 mass % in total of at least one additive element selected from Cu, Mg, and Si, and further containing 0.001 to 0.01 mass % in total of Ti and V, with the balance being Al and inevitable impurities,
wherein, on a cross-section vertical to a wire-drawing direction, a grain size is 1 to 20 μm, and a distribution density of a second phase with a size of 10 to 200 nm is 1 to 10² particles/μm².
(3) The aluminum alloy conductor according to (1) or (2), wherein a cooling speed in a casting step for the aluminum alloy conductor is 1 to 20° C./second, and wherein, on the cross-section vertical to the wire-drawing direction, the grain size is 1 to 5 μm.
(4) The aluminum alloy conductor according to any one of (1) to (3), which has a tensile strength of 100 MPa or more, an electrical conductivity of 55% IACS or more, and a tensile elongation at breakage of 10% or more.
(5) A method of producing the aluminum alloy conductor according to any one of (1) to (4), comprising the steps of: first wire-drawing, intermediate annealing, second wire-drawing, and finish annealing,
wherein, in the intermediate annealing step, a conductor at a working degree of 1 to 6 is heat-treated under heat treatment conditions of a temperature of 300° C. to 450° C., and a time period of 10 minutes to 6 hours.
(6) The method of producing the aluminum alloy conductor according to (5), wherein a rod before the first wire-drawing step is heat-treated under heat treatment conditions of a temperature of 300° C. to 450° C. and a time period of 10 minutes to 6 hours.
(7) The aluminum alloy conductor according to any one of (1) to (4), which is used as an electrical wiring.
(8) The aluminum alloy conductor according to any one of (1) to (4), and (7), which is used as a conductor wire for a battery cable, a wire harness, or a motor, each in a movable body, or as a material of a terminal thereof.
(9) The aluminum alloy conductor according to (8), wherein the movable body is an automobile, a train, or an aircraft.

### Advantageous Effects of Invention

The aluminum alloy conductor of the present invention is excellent in the mechanical strength, the flexibility, and the electrical conductivity, and is useful as an electrical wiring or a conductor wire for a battery cable, a harness, or a motor, each of which is mounted on a movable body. Further, since the aluminum alloy conductor of the present invention has high resistance to bending fatigue and resistance to stress relaxation, it can also be preferably used in doors, trunks, hoods (or bonnets), engine rooms, and the like, as well as in the applications in movable bodies, where those characteristics are required. Furthermore, since the aluminum alloy conductor of the present invention is excellent in workability, a problem, such as wire breakage in plastic working, is hardly occurred, and the productivity can be improved.

Other and further features and advantages of the invention will appear more fully from the following description, appropriately referring to the accompanying drawings.

### BRIEF DESCRIPTION OF THE DRAWINGS

FIG. 1 is an explanatory view of the test for measuring the number of repeating times at breakage, which was conducted in the Examples.

FIG. 2 is an explanatory view (TEM micrograph) of the first phase (matrix) and the second phase (dot-like shadows on the micrograph) in Example No. 5 shown below. The scale is that the length of the white line shown in the lower part of the micrograph corresponds to 250 nm.

FIG. 3 is a micrograph of the specimen (Example No. 5 shown below) taken, after the tensile test at room temperature.

### MODE FOR CARRYING OUT THE INVENTION

The aluminum alloy conductor of the present invention can be provided to have excellent resistance to bending fatigue, resistance to stress relaxation, workability, mechanical strength, flexibility, and electrical conductivity, by defining the alloy composition, the grain size, and the dispersion density of the second phase. Hereinafter, preferred embodiments of the present invention will be described in detail.

### First Embodiment

### (Alloy Composition)

A preferable first embodiment of the present invention has an alloy composition (i.e. a structure of alloying elements), which contains 0.01 to 0.4 mass % of Fe, 0.1 to 0.5 mass % of Cu, 0.04 to 0.3 mass % of Mg, and 0.02 to 0.3 mass % of Si, and further contains 0.001 to 0.01 mass % of Ti and V in total, with the balance being Al and inevitable impurities (herein, % in mass is represented by mass %).

Fe

In this embodiment, the reason why the content of Fe is set to 0.01 to 0.4 mass %, is to utilize various effects by mainly Al—Fe-based intermetallic compound. Fe is made into a solid solution in aluminum in an amount of only 0.05 mass % at 655° C., and is made into a solid solution lesser at room temperature. The remainder of Fe is crystallized or precipitated as intermetallic compounds, such as Al—Fe, Al—Fe—Si, Al—Fe—Si—Mg, and Al—Fe—Cu—Si. The crystallized or precipitated product acts as a refiner for grains to make the grain size fine, and enhances the mechanical strength and resistance to bending fatigue. On the other hand, the mechanical strength is enhanced also by the solid-solution of Fe. In this embodiment, when the content of Fe is equal to or more than the lower limit, the above effects are sufficiently obtained, and when the content is equal to or less than the upper limit, the resultant alloy conductor is not brought to a supersaturated solid solution state, and the electrical conductivity is not lowered excessively. The content of Fe is preferably 0.15 to 0.3 mass %, more preferably 0.18 to 0.25 mass %.

Cu

In this embodiment, the reason why the content of Cu is set to 0.1 to 0.5 mass %, is to make Cu into a solid solution in the aluminum matrix, to strengthen the resultant alloy. Furthermore, Cu also contributes to the improvement in creep resistance, resistance to bending fatigue, and heat resistance. When the content of Cu is equal to or more than the lower limit, the effects are sufficiently obtained, and when the content is equal to or less than the upper limit, excessive lowering in corrosion resistance and electrical conductivity do not occur. The content of Cu is preferably 0.20 to 0.45 mass %, more preferably 0.25 to 0.40 mass %.

Mg

In this embodiment, the reason why the content of Mg is set to 0.04 to 0.3 mass %, is to make Mg into a solid solution in the aluminum matrix, to strengthen the resultant alloy. Further, another reason is to make a part of Mg form a precipitate with Si, to make it possible to enhance mechanical strength and to improve resistance to bending fatigue and heat resistance. When the content of Mg is equal to or more than the upper limit, the effects are sufficiently obtained, and when the content is equal to or less than the upper limit, an excessive lowering in electrical conductivity does not occur. Furthermore, when the content of Mg is too large, the yield strength may become excessive, to deteriorate the formability and twistability, and to make the workability worse, in some cases. The content of Mg is preferably 0.15 to 0.3 mass %, more preferably 0.2 to 0.28 mass %.

Si

In this embodiment, the reason why the content of Si is set to 0.02 to 0.3 mass %, is to make Si into a solid solution in the aluminum matrix, to strengthen the resultant alloy. Further, another reason is to make a part of Si form a precipitate with Fe, Mg or the like, to make it possible to enhance mechanical strength and to improve resistance to bending fatigue and resistance to stress relaxation. When the content of Si is equal to or more than the lower limit, the effects are sufficiently obtained, and when the content is equal to or less than the upper limit, an excessive lowering in electrical conductivity does not occur. The content of Si is preferably 0.06 to 0.25 mass %, more preferably 0.10 to 0.25 mass %.

Ti, V

In this embodiment, Ti and V each act as a refiner for grains of an ingot in melt-casting. If the microstructure of the ingot is not excessively coarsened, cracking does not occur in the wire-drawing step, which is industrially preferable. When the content of Ti and V is equal to or more than the lower limit, the effects are sufficiently obtained, and when the content is equal to or less than the upper limit, a large lowering in electrical conductivity does not occur, which is preferable. The content of Ti and V in total is preferably 0.002 to 0.008 mass %, more preferably 0.003 to 0.006 mass %.

### Second Embodiment

### (Alloy Composition)

A preferable second embodiment of the present invention has an alloy composition, which contains 0.4 to 1.2 mass % of Fe, 0.02 to 0.5 mass % of at least one additive element selected from Cu, Mg, and Si in total, and further contains 0.001 to 0.01 mass % of Ti and V in total, with the balance being Al and inevitable impurities.

Fe In this embodiment, the reason why the content of Fe is set to 0.4 to 1.2 mass %, is to utilize the various effects by mainly Al—Fe-based intermetallic compound, similarly to the first embodiment. This is set such that the mechanical strength and the resistance to bending fatigue are enhanced largely, by containing the amount of Fe larger than that of the first embodiment. Accordingly, in regard to Cu, Mg, and Si that will be described below, the composition is set within the range appropriately. When the content of Fe is equal to or more than the lower limit, those effects are sufficiently obtained, and when the content is equal to or less than the upper limit, the target resistance to bending fatigue is obtained, without causing deterioration of wire-drawing property due to coarsening of the crystallized product. Furthermore, the resultant alloy conductor is not brought to a supersaturated solid solution state, and the electrical conductivity is not lowered. The content of Fe is preferably 0.4 to 0.9 mass %, more preferably 0.6 to 0.9 mass %.

Cu, Mg, Si

In this embodiment, the reason why the total content of at least one additive element selected from Cu, Mg, and Si is set to 0.02 to 0.5 mass %, is that this is a range set to exhibit the target effects of the present invention in this embodiment in which a particular amount of Fe is contained as described above. When this content is equal to or more than the lower limit, sufficient effects are obtained, to enhance mechanical strength, resistance to bending fatigue, and resistance to stress relaxation, and when the content is equal to or less than the upper limit, electrical conductivity is not lowered excessively. The total content of at least one additive element selected from Cu, Mg, and Si is preferably 0.1 to 0.5 mass %, more preferably 0.15 to 0.4 mass %.

Other alloy composition (alloying elements) and the effects thereof are similar to those in the above first embodiment.

### (Grain Size)

In the present invention, the grain size is 1 to 20 μm on the cross-section vertical to the wire-drawing direction of the aluminum wire. When the grain size is equal to or more than the lower limit, no unrecrystallized microstructure remains, and the elongation is enhanced sufficiently. When the grain size is equal to or less than the upper limit, the deformation behavior becomes even, and the mechanical strength and flexibility are enhanced sufficiently. Furthermore, in the present invention, the particle size is set preferably 1 to 15 μm, particularly preferably 1 to 5 μm. This is because, in such a smaller grain size region, the resistance to bending fatigue is further improved. The “grain size” in the present invention is an average grain size obtained by conducting a grain size measurement with an intersection method by observing with an optical microscope, and is an average value of 50 to 100 grains. Herein, unless specified otherwise, in the present invention, the specific measurement method and measurement procedures for the grain size are based on the example described in the Example section.

### (Size and Dispersion Density of Second Phase)

The present invention contains a second phase at a predetermined dispersion density, as disclosed in the first and second embodiments. Herein, the second phase refers to particles of a crystallized product, a precipitate, or the like, each of which is exist in the inside of the conductor in interest. Mainly, a crystallized product that constitutes the second phase is formed in melt-casting, and a precipitate is formed in intermediate annealing and finish annealing. Examples thereof include particles of Al—Fe, Al—Fe—Si, Al—Fe—Si—Cu, and Mg—Si. In contrast to this, the first phase represents Al (grains of the matrix), which is the subject of measurement of the above grain size. In this Al, a portion of the additive element(s) and/or inevitable impurity element(s) is made into a solid solution. In general, the first phase is referred to as a matrix. The dispersion density is a value obtained by converting the number of second phases that are contained in the conductor in interest, to a value per μm², and the dispersion density can be calculated based on a micrograph taken by TEM. Herein, unless specified otherwise, in the present invention, the specific measurement method and measurement procedures for the dispersion density are based on the example described in the Example section.

In the present invention, attention was paid to the second phase of particle size 10 to 200 nm. Those are mainly composed of Al—Fe, Al—Fe—Si, Al—Fe—Cu, Al—Fe—Si—Cu, Mg—Si, or the like, as described above. Such a second phase works as a refiner for making grains fine in size, and also enhances mechanical strength and improves resistance to bending fatigue. The reason why the dispersion density of the second phase is set to 1 to 10² particles/μm², is that, when the dispersion density is equal to or more than the lower limit, those effects are sufficiently obtained, and when the dispersion density is equal to or less than the upper limit, the second phase particles do not cause wire breakage in wire drawing. The dispersion density of the second phase is preferably 1 to 80 particles/μm², more preferably 10 to 60 particles/μm².

In the first and second embodiments of the present invention, the respective alloy compositions are set to the ranges described above, to obtain the aluminum alloy conductor having the grain size and the dispersion density of the second phase described above. Further, the grain size and the dispersion density can be realized, by suitably controlling the cooling speed in casting, the intermediate annealing conditions, the finish annealing conditions, and the like. A preferable production method will be described below.

### (Production Method)

The aluminum alloy conductor of the present invention can be produced via steps containing: first wire-drawing, heat treatment (intermediate annealing), second wire-drawing, and heat treatment (finish annealing). More specifically, the aluminum alloy conductor of the present invention can be produced via steps of: [1] melting, [2] casting, [3] hot- or cold-working (e.g. caliber rolling with grooved rolls), [4] first wire-drawing, [5] heat treatment (intermediate annealing), [6] second wire-drawing, and [7] heat treatment (finish annealing).

The melting is conducted by melting predetermined alloying elements each at a given content that gives the given concentration of each embodiment of the aluminum alloy composition mentioned above.

Then, the resultant molten metal is rolled while the molten metal is continuously cast in a water-cooled casting mold, by using a Properzi-type continuous cast-rolling machine which has a casting ring and a belt in combination, to give a rod of about 10 mm in diameter. The cooling speed in casting at that time is 1 to 50° C./sec. Further, by setting the cooling speed in casting to 1 to 20° C./sec, the resultant numerous second phase particles can also suppress growth of recrystallized grains in the later step, to give an aluminum alloy conductor having a grain size of 1 to 5 μm. The casting and hot rolling may be conducted by billet casting, extrusion, or the like. Further, the resultant rod (for example, about 10 mmφ) before the first wire-drawing is preferably subjected to a heat treatment under the heat treatment conditions of a temperature of 300° C. to 450° C. and a time period of 10 minutes to 6 hours. When the temperature and time period for this heat treatment of the rod are equal to or more than the lower limits, the temperature and time period are sufficient necessary for formation of a precipitate, and when the temperature and time period are equal to or less than the upper limits, saturation of the amount of the precipitate to be formed can be prevented, to make it possible to cut off the loss of production time period. Preferably, the temperature is 300° C. to 400° C., and the time period is 1 hour to 4 hours.

Then, surface stripping of the resultant rod is conducted to adjust the diameter to 9 to 9.5 mm, and the thus-stripped rod is subjected to wire drawing. The working degree (or degree of working) is preferably from 1 to 6. Herein, the working degree η is represented by: η=ln(A₀/A₁), in which the cross-sectional area of the wire (or rod) before the wire drawing is represented by A₀, and the cross-sectional area of the wire after the wire drawing is represented by A₁. When the working degree at this time is equal to or more than the lower limit, the recrystallized grains are not made to be coarsened in the heat treatment in the subsequent step, to obtain sufficient mechanical strength and elongation, to make it possible to prevent wire breakage from being occurred. When the working degree is equal to or less than the upper limit, the resultant mechanical strength does not become excessively high and no excessive force is required in the wire drawing, to make it possible to prevent wire breakage from being occurred in wire drawing.

The thus-worked product that (i.e. a roughly-drawn wire) has undergone cold-wire drawing (first wire-drawing), is subjected to intermediate annealing. The intermediate annealing is mainly conducted for recovering the flexibility of a wire that has been hardened by wire drawing. When the intermediate annealing temperature is set to a predetermined temperature range, any occurrence of wire breakage in the later wire drawing can be prevented from being occurred. From this point of view, the intermediate annealing temperature is preferably 300° C. to 450° C., more preferably 300° C. to 400° C. The time period for the intermediate annealing is preferably set to 10 minutes to 6 hours. This is because, when the time period is equal to or more than this lower limit, the time period necessary for the formation and growth of recrystallized grains becomes sufficient, and flexibility of the wire can be recovered. On the other hand, when the time period is equal to or less than the upper limit, the effect of recovering flexibility of the wire is saturated, and the loss of the production time period can be prevented. In addition, lowering in the mechanical strength and elongation caused by over-annealing can be prevented, and wire breakage can be prevented from being occurred. The time period is preferably 1 to 4 hours. Furthermore, although the average cooling speed from the heat treatment temperature in the intermediate annealing to 100° C. is not particularly defined, it is preferably 0.1 to 10° C./min.

The thus-annealed roughly-drawn wire is further subjected to wire drawing (second wire-drawing). At that time, the working degree (the working degree before the finish annealing) is set to be from 1 to 6, to obtain the above-mentioned grain size. The working degree has a significant influence on the formation and growth of recrystallized grains. When the working degree is equal to or more than the lower limit, the recrystallized grains are not made to be coarsened in the heat treatment in the subsequent step, to obtain sufficient mechanical strength and elongation, to make it possible to prevent wire breakage from being occurred. When the working degree is equal to or less than the upper limit, the resultant mechanical strength does not become excessively high and no excessive force is required in the wire drawing, to make it possible to prevent wire breakage from being occurred in wire drawing. The working degree is preferably from 2 to 6.

The thus-worked product (i.e. a drawn wire) that has undergone cold-wire drawing, is subjected to finish annealing by continuous electric heat treatment. The continuous electric heat treatment is conducted through annealing by the Joule heat generated from the wire in interest itself that is running continuously through two electrode rings, by passing an electrical current through the wire. The continuous electric heat treatment has the steps of: rapid heating; and quenching, and can conduct annealing of the wire, by controlling the temperature of the wire and the time period for the annealing. The cooling is conducted, after the rapid heating, by continuously passing the wire through water or a nitrogen gas atmosphere. In one of or both of the case where the wire temperature in annealing is too low and the case where the annealing time period is too short, the flexibility that is required for attaching the resultant wire to vehicle to mount thereon cannot be obtained; and, on the other hand, in one of or both of the case where the wire temperature in annealing is too high and the case where the annealing time period is too long, the recrystallized grains are made to be coarsened, to fail to secure any sufficient mechanical strength and elongation, and to result in that the resultant resistance to bending fatigue also becomes worse. Thus, the above-mentioned target grain size can be given, by conducting the continuous electric heat treatment under the conditions satisfying the following relationships.

Namely, when a wire temperature is represented by y (° C.) and an annealing time period is represented by x (sec), the continuous electric heat treatment is conducted under the conditions that satisfy:

0.03≦x≦0.55, and

26x^{-0.6}+377≦y≦19x^{-0.6}+477.

The wire temperature y (° C.) represents the temperature of the wire immediately before passing through into the cooling step, at which the temperature of the wire is the highest. The y (° C.) is generally within the range of 414 to 633 (° C.).

### (Tensile Strength)

The reason why the tensile strength of the aluminum alloy conductor of the present invention is defined to be 100 MPa or more, is that no wire breakage occurs at the time of installation or after installation of it in a vehicle or the like. When the tensile strength is equal to or more than the value, the conductor can tolerate to the force of drawing the resultant wire of the conductor. The tensile strength is more preferably 100 MPa to 180 MPa.

### (Electrical Conductivity)

The reason why the electrical conductivity of the aluminum alloy conductor of the present invention is defined to be 55% or more, is to secure a sufficient electrical conductivity. The electrical conductivity is more preferably 58% IACS to 62% IACS.

### (Tensile Elongation at Breakage)

The reason why the tensile elongation at breakage of the aluminum alloy conductor of the present invention is defined to be 10% or more, is that the resultant wire of the conductor has a sufficient flexibility at the time of installation or after installation of it in a vehicle or the like, to enhance the wire-running property (the installation property). When the tensile elongation at breakage is equal to or more than the value, a sufficient wire-running property is obtained, and a large force is not necessary at the time of installation of the wire of the conductor in a vehicle or the like. In addition to the above, wire breakage hardly occurs. The tensile elongation at breakage is more preferably 10 to 30%.

The aluminum alloy conductor of the present invention that is produced by properly subjecting to the heat treatments as described in detail above, has the predetermined grain size and the dispersion state (dispersion density) of the second phase as described above, and also has a recrystallized microstructure. Herein, the recrystallized microstructure refers to a microstructural state that is constituted by grains being less in lattice defects, such as dislocations, introduced by plastic working. Since the aluminum alloy conductor has the recrystallized microstructure, the tensile elongation at breakage and electrical conductivity are recovered, and a sufficient flexibility can be obtained.

### EXAMPLES

The present invention will be described in more detail based on examples given below, but the invention is not meant to be limited by these.

### Examples 1 to 20, and Comparative Examples 1 to 18

Fe, Cu, Mg, Si, Ti, V and Al in the amounts (mass %), as shown in Tables 1 and 2, were made into the respective molten metals, followed by rolling, while continuously casting in a water-cooled casting mold, by using a Properzi-type continuous cast-rolling machine, to give respective rods with diameter about 10 mmφ. At that time, the cooling speed in casting was 1 to 50° C./sec (in Comparative examples, the cases of 0.1° C./sec or 70° C./sec were also included). In Example 19, a rod of about 10 mmφ was subjected to a heat treatment at 350° C. for 2 hours, and in Example 20, a rod of about 10 mmφ was subjected to a heat treatment at 400° C. for 1 hour.

Then, stripping off of the surface of the rods was conducted, to the diameter of about 9.5 mmφ, followed by wire drawing to attain a given working degree, respectively. Then, as shown in Tables 1 and 2, the thus-roughly-cold-drawn wires were subjected to intermediate annealing at a temperature of 300 to 450° C. (in Comparative examples, the cases of 250° C. or 550° C. were also included) for 0.17 to 4 hours, followed by wire drawing to a given wire diameter.

The working history of the wire drawings conducted in Examples and Comparative examples are shown below.

| Before first | After first | Intermediate | After second |
|---|---|---|---|
| wire-drawing | wire-drawing | annealing | wire-drawing |
| 9.5 mmφ | 0.64 mmφ | Intermediate | 0.43 mmφ |
| | (η = 5.4) | annealing | (η = 0.8) |
| 9.5 mmφ | 0.72 mmφ | Intermediate | 0.31 mmφ |
| | (η = 5.2) | annealing | (η = 1.7) |
| 9.5 mmφ | 1.4 mmφ | Intermediate | 0.31 mmφ |
| | (η = 3.8) | annealing | (η = 3.0) |
| 9.5 mmφ | 2.6 mmφ | Intermediate | 0.37 mmφ |
| | (η = 2.6) | annealing | (η = 3.9) |
| 9.5 mmφ | 2.6 mmφ | Intermediate | 0.31 mmφ |
| | (η = 2.6) | annealing | (η = 4.3) |
| 9.5 mmφ | 4.8 mmφ | Intermediate | 0.31 mmφ |
| | (η = 1.4) | annealing | (η = 5.5) |
| 9.5 mmφ | 6.4 mmφ | Intermediate | 0.43 mmφ |
| | (η = 0.8) | annealing | (η = 5.4) |
| 9.5 mmφ | 0.43 mmφ | | |
| | (η = 6.2) | | |

Finally, as the finish annealing, a continuous electric heat treatment was conducted under the conditions at a temperature of 458 to 625° C. for a time period of 0.03 to 0.54 seconds. The temperature was the wire temperature measured at immediately before passage into water, at which the temperature of the wire would be the highest, with a fiber-type radiation thermometer (manufactured by Japan Sensor Corporation).

### Comparative Example 19

As shown in Table 2 below, Fe, Cu, Mg, and Al were melted in a usual manner at a predetermined amount ratio (mass %), followed by being cast in a casting mold of 25.4 mm square, to give an ingot. The ingot was then kept at 400° C. for 1 hour, followed by hot rolling by grooved rolls, thereby to work into a roughly-drawn rod with rod diameter 9.5 mm.

The roughly-drawn rod was then subjected to wire drawing to wire diameter 0.9 mm, followed by heat treatment by maintaining at 350° C. for 2 hours, quenching, and further continuing wire drawing, thereby to prepare an aluminum alloy element wire with wire diameter 0.32 mm.

Finally, the thus-prepared aluminum alloy element wire with wire diameter 0.32 mm, was subjected to heat treatment by maintaining at 350° C. for 2 hours, followed by cooled slowly.

### Comparative Example 20

As shown in Table 2 below, Fe, Mg, Si, and Al were melted in a usual manner at a predetermined amount ratio (mass %), followed by working into a roughly-drawn rod with rod diameter 9.5 mm by continuous cast-rolling.

The roughly-drawn rod was then subjected to wire drawing to wire diameter 2.6 mm, followed by heat treatment by maintaining at 350° C. for 2 hours so that the tensile strength after the heat treatment would be 150 MPa or less, and further continuing wire drawing, thereby to prepare an aluminum alloy element wire with wire diameter 0.32 mm.

### Comparative Example 21

As shown in Table 2 below, Fe, Mg, Si, and Al were melted at a predetermined amount ratio (mass %) to give an alloy molten metal, followed by being cast in a continuous casting machine, to give a cast bar. Then, from the cast bar, a wire rod of φ9.5 mm was prepared by using a hot-rolling machine, and the thus-obtained wire rod was subjected to cold-wire drawing to φ0.26 mm, followed by subjecting to softening treatment, and further cold-wire drawing, to prepare an electrical elemental wire of 0.26 mmφ.

Then, seven of the resultant electrical element wires were twisted together, to form a twisted wire. Then, the resultant twisted wire was subjected to solution treatment, followed by cooling and aging heat treatment, to give an electrical wire conductor. At that time, the temperature in the solution treatment was 550° C., the annealing temperature in the aging heat treatment was 170° C., and the annealing time period was 12 hours. The twisted wire was unwound or untied, to take out one element wire, which was evaluated on the properties, as shown in Table 2, except for the RA value.

With respect to the wires thus-prepared in Examples (Ex) according to the present invention, Comparative examples (Comp ex), the properties were measured according to the methods described below. The results are shown in Tables 1 and 2.

### (a) Grain Size (GS)

The transverse cross-section of the respective wire sample cut out vertically to the wire-drawing direction, was filled with a resin, followed by mechanical polishing and electrolytic polishing. The conditions of the electrolytic polishing were as follows: polish liquid, a 20% ethanol solution of perchloric acid; liquid temperature, 0 to 5° C.; voltage, 10 V; current, 10 mA; and time period, 30 to 60 seconds. Then, in order to obtain a contrast of grains, the resultant sample was subjected to anodizing finishing, with 2% hydrofluoroboric acid, under conditions of voltage 20 V, electrical current 20 mA, and time period 2 to 3 min. The resultant microstructure was observed to take a micrograph by an optical microscope with a magnification of 200× to 400×, and the grain size was measured by an intersection method. Specifically, a straight line was drawn arbitrarily on the micrograph taken, and the number of intersection points at which the length of the straight line intersected with the grain boundaries was measured, to determine an average grain size. The grain size was evaluated by changing the length and the number of straight lines so that 50 to 100 grains would be counted.

### (b) Size (Particle Size) and Dispersion Density of Second Phase

The wires obtained in Examples and Comparative examples were made into thin films by an FIB method, respectively, followed by observing arbitrary areas thereof by using a transmission electron microscope (TEM) with a magnification of 10,000× to 60,000×. The size of the second phase was determined from the scale of the micrographs taken, by converting the shape of the individual particle to a circle having the same area of the particle in interest, to calculate the diameter of the circle. The dispersion density of the second phase was calculated, by defining an area where 10 to 30 particles would be counted, and calculating the dispersion density of the second phase by the formula:

Dispersion density (particles/μm²)=The number of second phase (particles)/Subject area for counting (μm²).

The dispersion density of the second phase is calculated, by taking the reference thickness of 0.15 μm for the sample thickness of the thin film. In the case where the sample thickness and the reference thickness are different from each other, the dispersion density can be calculated, by multiplying the sample thickness in terms of the reference thickness, that is, a value of (reference thickness/sample thickness) by the dispersion density calculated based on the micrograph taken. In Examples and Comparative examples, the sample thickness is calculated, by observing the interval of equal-thickness streaks observed from the micrograph, and it has been confirmed that the thickness is almost equal to 0.15 μm in all the samples.

### (c) Tensile Strength (TS) and Flexibility (Tensile Elongation at Breakage, EI)

Three test pieces for each sample were tested according to JIS Z 2241, and the average value was obtained, respectively. A tensile strength of 100 MPa or more was judged as passing the criterion. For flexibility, a tensile elongation at breakage of 10% or more was judged as passing the criterion.

### (d) Electrical Conductivity (EC)

Specific resistivity of three test pieces with length 300 mm for each sample was measured, by using a four-terminal method, in a thermostatic bath kept at 20° C. (±0.5° C.), to calculate the average electrical conductivity therefrom. The distance between the terminals was set to 200 mm. An electrical conductivity of 55% IACS or more was judged to pass the criterion, and an electrical conductivity of 58% IACS or more was judged to be better.

### (e) the Number of Repeating Times at Breakage

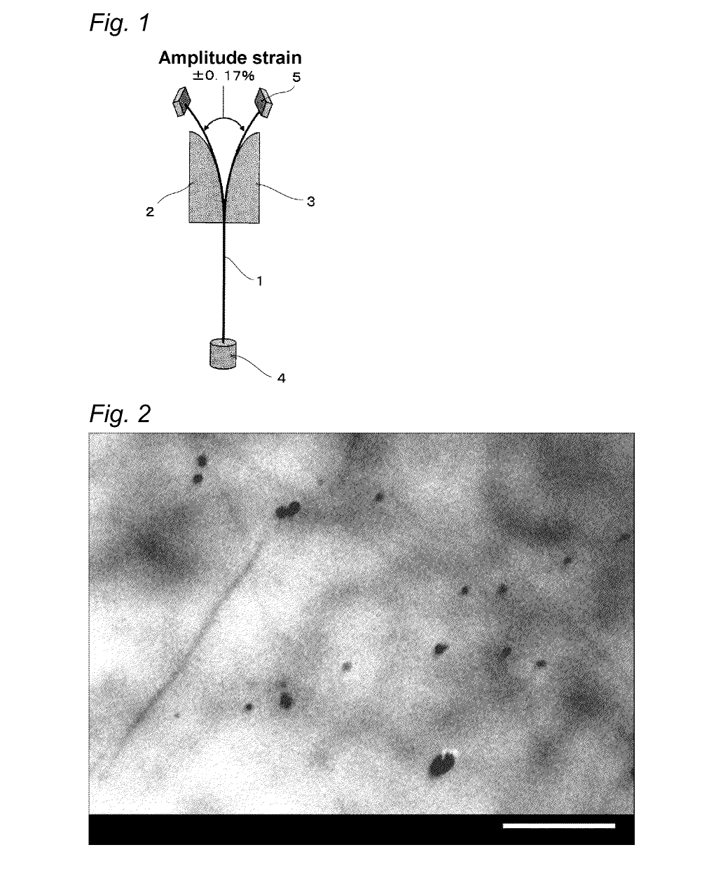

As a criterion for the resistance to bending fatigue, a strain amplitude at an ordinary temperature was set to ±0.17%. The resistance to bending fatigue varies depending on the strain amplitude. When the strain amplitude is large, the resultant fatigue life is short, while when small, the resultant fatigue life is long. Since the strain amplitude can be determined by the wire diameter of a wire 1 and the curvature radii of bending jigs 2 and 3 as shown in FIG. 1, a bending fatigue test can be conducted by arbitrarily setting the wire diameter of the wire 1 and the curvature radii of the bending jigs 2 and 3.

Using a reversed bending fatigue test machine manufactured by Fujii Seiki, Co. Ltd. (currently renamed to Fujii, Co. Ltd.), and using jigs that can impart a bending strain of 0.17% to the wire, the number of repeating times at breakage was measured, by conducting repeated bending. The number of repeating times at breakage was measured from 4 test pieces for each sample, and the average value thereof was obtained. As shown in the explanatory view of FIG. 1, the wire 1 was inserted between the bending jigs 2 and 3 that were spaced by 1 mm, and moved in a reciprocate manner along the jigs 2 and 3. One end of the wire was fixed on a holding jig 5 so that bending can be conducted repeatedly, and a weight 4 of about 10 g was hanged from the other end. Since the holding jig 5 moves in the test, the wire 1 fixed thereon also moves, thereby that repeating bending can be conducted. The repeating was conducted under the condition of 1.5 Hz (1.5 times of reciprocation in 1 second), and the test machine has a mechanism in which the weight 4 falls to stop counting when the test piece of the wire 1 is broken. The number of repeating times at breakage of 80,000 or more was judged to pass the criterion.

### (f) Resistance to Stress Relaxation (Tensile Strength Change Rate)

As an index of the resistance to stress relaxation, the tensile strength change rate after a heat treatment at 160° C. for 120 hours was measured. Specifically, after the finish annealing, the resultant aluminum alloy conductor was worked at a working ratio of 5 to 50%, followed by subjecting to the heat treatment for 120 hours in a thermostatic bath (in the air) controlled at 160° C. (±5° C.), and then being cooled naturally (being left to cool). Then, to the resultant conductor, the tensile test was carried out in the same manner as in the (c) above. The tensile strength before the heat treatment and the tensile strength after the heat treatment were measured, respectively, to determine the tensile strength change rate (%). The test was carried out for three test specimens for the respective samples, and the average value was determined.

As a method for evaluating the resistance to stress relaxation, use was made of an evaluation method based on the Larson-Miller parameter (LM: see formula 1 below).

(LM)=(temperature+273)×(20+Log(time)) (Formula 1)

Regarding the units, the unit for the temperature is ° C., and the unit for the time period is h. This is a way of equivalently evaluating the received thermal energy, in experiments in which the temperature and the time period are changed. When the test at 160° C. for 120 hours is replaced with 120° C. which is the maximum temperature in an engine room of a car, it is equivalent to a test at 120° C. for 21,200 hours. However, in the engine room of a car, the temperature 120° C. is not continuously maintained, and the temperature is lowered when the engine is stopped. If the time period in which the temperature is maintained at 120° C. in the use of one day is assumed to be 2 hours in total, the test at 160° C. for 120 hours is equivalent to the use at 120° C. for 29 years, to secure a service life of 20 years or more. Therefore, the heat treatment conditions of 160° C. for 120 hours were employed in this test.

The reason why the working ratio of 5 to 50% was applied to the aluminum alloy conductor is as follows, with assuming an occasion in which the aluminum alloy conductor and a terminal (connector) made of copper are joined as described above. When the working ratio is less than 5%, the joint strength is not satisfactory and the electrical connection is not satisfactory; and when the working ratio is more than 50%, there is a risk of breakage of the aluminum alloy conductor.

The tensile strength change rate of −5% or more was judged to pass the criterion. This is because, if deterioration of the tensile strength does not exceed 5% (if the change ratio is not smaller than −5%), generally, the contact pressure at the connected portion between the aluminum conductor and the terminal does not become to be too low, to make it possible to maintain a satisfactory electrical connection.

### (g) Workability (RA Value)

As an index for the evaluation of workability, use was made of the cross-sectional area reduction ratio (RA value), which is the ratio of cross-sectional areas before and after the tensile test. The RA value is the ratio of vertical cross-sectional areas in the tensile test direction before and after the tensile test, and is represented by the following formula:

RA value (%)={1−(cross-sectional area after tensile test/cross-sectional area before tensile test)×100

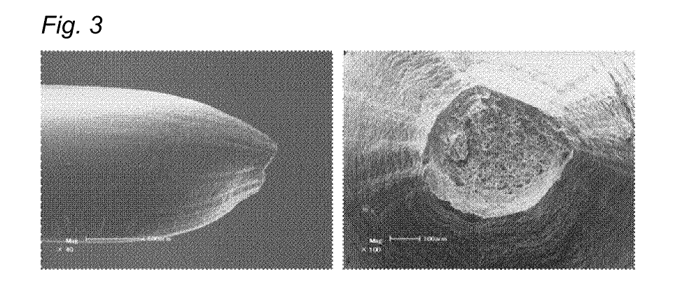

In this test, use was made of a test specimen having a circular cross-section and an initial cross-sectional area of about 1.5 mm² (diameter 1.4 mm), which was one in the mid course of the wire drawing [6]. This is because, when cold workability is evaluated, if the cross-sectional area is 1.2 mm² or less, the RA value cannot be measured accurately, and if the specimen is one in the mid course of the wire drawing [4], results reflecting the influence of the intermediate annealing cannot be obtained. In Comparative example 19, results that reflect the influence of the intermediate annealing cannot be obtained, but as a reference value, measurement was made, by using a specimen of about 1.5 mm² (diameter 1.4 mm). The test was carried out with three specimens for each samples, under the same test conditions as those in the above (c), at the test temperatures of room temperature (20° C.) and 200° C. (deviation ±5° C.). The cross-sectional area after the test was determined, by observing a tensile broken face with a scanning electron microscope (SEM), followed by calculating the average of two broken faces for one specimen by using an image analyzer, and calculating the average value for three specimens of the same sample. FIG. 3 shows the specimen of Example No. 5 after the tensile test at room temperature. When the RA value thus obtained was 80% or more, workability was judged to be satisfactory. The RA value is preferably 90% or more.

TABLE 1
(Examples)

| | | | | | | | Cooling | Intermediate | Intermediate | | Finish | | | | |
|---|---|---|---|---|---|---|---|---|---|---|---|---|---|---|---|
| | | | | | Ti + | | speed in | working | annealing | | working | Finish annealing | | | |
| | Fe | Cu | Mg | Si | V | Al | casting | degree | Temp. | Time | degree | Temp. y | Time x | 26x^{-0.6} + | 19x^{-0.6} + |
| No. | (mass %) | | | | | | (° C./sec) | η | (° C.) | (h) | η | (° C.) | (s) | 377 | 477 |
| 1 | 0.02 | 0.49 | 0.23 | 0.21 | 0.003 | bal. | 10 | 5.2 | 350 | 2 | 1.7 | 508 | 0.11 | 476 | 548 |
| 2 | 0.05 | 0.24 | 0.11 | 0.23 | 0.002 | bal. | 5 | 1.4 | 300 | 1 | 5.5 | 505 | 0.11 | 476 | 548 |
| 3 | 0.05 | 0.15 | 0.27 | 0.06 | 0.003 | bal. | 5 | 2.6 | 300 | 1 | 4.3 | 625 | 0.03 | 590 | 632 |
| 4 | 0.08 | 0.46 | 0.08 | 0.06 | 0.002 | bal. | 1 | 2.6 | 350 | 2 | 4.3 | 463 | 0.18 | 450 | 530 |
| 5 | 0.12 | 0.18 | 0.30 | 0.27 | 0.005 | bal. | 20 | 3.8 | 400 | 6 | 3 | 484 | 0.18 | 450 | 530 |
| 6 | 0.15 | 0.30 | 0.15 | 0.30 | 0.003 | bal. | 1 | 1.4 | 400 | 0.17 | 5.5 | 467 | 0.54 | 415 | 504 |
| 7 | 0.20 | 0.42 | 0.21 | 0.02 | 0.003 | bal. | 5 | 2.6 | 300 | 1 | 4.3 | 516 | 0.11 | 476 | 548 |
| 8 | 0.21 | 0.34 | 0.06 | 0.10 | 0.003 | bal. | 50 | 3.8 | 350 | 2 | 3 | 613 | 0.03 | 590 | 632 |
| 9 | 0.26 | 0.10 | 0.19 | 0.25 | 0.007 | bal. | 5 | 2.6 | 300 | 2 | 4.3 | 538 | 0.11 | 476 | 548 |
| 10 | 0.26 | 0.37 | 0.15 | 0.21 | 0.003 | bal. | 15 | 2.6 | 350 | 0.5 | 4.3 | 607 | 0.03 | 590 | 632 |
| 11 | 0.31 | 0.40 | 0.25 | 0.12 | 0.002 | bal. | 1 | 3.8 | 350 | 0.5 | 3 | 472 | 0.18 | 450 | 530 |
| 12 | 0.31 | 0.13 | 0.04 | 0.12 | 0.008 | bal. | 5 | 2.6 | 350 | 2 | 4.3 | 504 | 0.11 | 476 | 548 |
| 13 | 0.34 | 0.12 | 0.19 | 0.23 | 0.003 | bal. | 20 | 3.8 | 450 | 2 | 3 | 609 | 0.03 | 590 | 632 |
| 14 | 0.38 | 0.22 | 0.12 | 0.28 | 0.005 | bal. | 10 | 1.4 | 350 | 2 | 5.5 | 458 | 0.18 | 450 | 530 |
| 15 | 0.40 | 0.30 | 0.25 | 0.11 | 0.003 | bal. | 5 | 2.6 | 350 | 1 | 4.3 | 515 | 0.11 | 476 | 548 |
| 16 | 0.25 | 0.30 | 0.12 | 0.13 | 0.008 | bal. | 10 | 2.6 | 350 | 2 | 3.9 | 501 | 0.11 | 476 | 548 |
| 17 | 0.80 | 0.21 | 0.12 | 0.15 | 0.002 | bal. | 10 | 2.6 | 400 | 1 | 4.3 | 498 | 0.18 | 450 | 530 |
| 18 | 1.10 | 0.10 | 0.11 | 0.08 | 0.003 | bal. | 5 | 2.6 | 350 | 1 | 4.3 | 497 | 0.18 | 450 | 530 |
| 19 | 0.30 | 0.12 | 0.15 | 0.10 | 0.005 | bal. | 10 | 2.6 | 350 | 2 | 4.3 | 510 | 0.11 | 476 | 548 |
| 20 | 0.90 | 0.15 | 0.11 | 0.08 | 0.005 | bal. | 10 | 2.6 | 400 | 2 | 4.3 | 511 | 0.11 | 476 | 548 |

| | | | | | | (e) | | | | |
|---|---|---|---|---|---|---|---|---|---|---|
| | | | | | | The number | | | | |
| | | (b) | | | | of repeating | (f) | (f) | | |
| | (a) | Particle | (c) | (c) | (d) | times at | Working | TS change | (g) RA value | |
| | GS | density | TS | EI | EC | breakage | ratio | rate | at 20° C. | at 200° C. |
| No. | (μm) | (/μm²) | (MPa) | (%) | (% IACS) | ×10⁴ | (%) | (%) | (%) | (%) |
| 1 | 18.0 | 22 | 136 | 20.8 | 56.9 | 12.9 | 20 | 7.9 | 97 | 90 |
| 2 | 17.6 | 18 | 117 | 17.2 | 59.1 | 10.4 | 50 | 5.6 | 86 | 80 |
| 3 | 13.3 | 14 | 110 | 20.8 | 60.3 | 9.5 | 10 | 5.4 | 83 | 87 |
| 4 | 9.5 | 22 | 127 | 20.7 | 60.1 | 12.6 | 10 | 0.8 | 89 | 90 |
| 5 | 11.6 | 27 | 123 | 18.3 | 56.9 | 9.8 | 30 | 6.1 | 89 | 86 |
| 6 | 9.5 | 32 | 129 | 18.3 | 57.2 | 11.0 | 40 | 6.5 | 98 | 93 |
| 7 | 8.2 | 34 | 133 | 19.4 | 59.4 | 12.2 | 40 | 2.1 | 84 | 88 |
| 8 | 7.8 | 33 | 126 | 20.0 | 60.1 | 11.4 | 5 | 0.6 | 82 | 81 |
| 9 | 11.4 | 37 | 120 | 18.5 | 57.9 | 9.0 | 40 | 3.3 | 87 | 89 |
| 10 | 7.3 | 42 | 137 | 18.7 | 57.7 | 11.7 | 20 | 7.1 | 81 | 88 |
| 11 | 4.8 | 47 | 142 | 18.0 | 57.8 | 12.0 | 30 | 7.5 | 87 | 88 |
| 12 | 5.6 | 38 | 116 | 26.5 | 60.4 | 9.3 | 30 | 1.3 | 81 | 81 |
| 13 | 4.3 | 45 | 125 | 18.5 | 58.4 | 9.2 | 40 | 4.0 | 80 | 88 |
| 14 | 2.2 | 52 | 133 | 18.1 | 57.4 | 10.2 | 40 | 5.4 | 93 | 93 |
| 15 | 2.8 | 53 | 139 | 17.2 | 58.2 | 11.0 | 20 | 6.9 | 87 | 82 |
| 16 | 8.7 | 40 | 132 | 19.5 | 59.0 | 11.2 | 20 | 2.8 | 90 | 92 |
| 17 | 3.6 | 78 | 143 | 20.8 | 58.7 | 10.1 | 40 | 5.2 | 82 | 85 |
| 18 | 1.5 | 86 | 136 | 22.3 | 59.6 | 9.0 | 20 | 1.6 | 85 | 82 |
| 19 | 8.2 | 48 | 122 | 22.4 | 59.8 | 9.5 | 20 | 1.8 | 86 | 88 |
| 20 | 3.3 | 75 | 138 | 19.6 | 58.3 | 9.9 | 20 | 2.1 | 83 | 84 |

TABLE 2
(Comparative examples)

| | | | | | | | Cooling | Intermediate | Intermediate | | Finish | | | | |
|---|---|---|---|---|---|---|---|---|---|---|---|---|---|---|---|
| | | | | | Ti + | | speed in | working | annealing | | working | Finish annealing | | | |
| | Fe | Cu | Mg | Si | V | Al | casting | degree | Temp. | Time | degree | Temp. y | Time x | 26x^{-0.6} + | 19x^{-0.6 +} |
| No. | (mass %) | | | | | | (° C./sec) | η | (° C.) | (h) | η | (° C.) | (s) | 377 | 477 |
| 1 | 0.20 | 0.02 | 0.15 | 0.15 | 0.003 | bal. | 10 | 2.6 | 350 | 1 | 4.3 | 510 | 0.11 | 476 | 548 |
| 2 | 0.20 | 0.70 | 0.15 | 0.15 | 0.002 | bal. | 10 | 2.6 | 350 | 1 | 4.3 | 511 | 0.11 | 476 | 548 |
| 3 | 0.21 | 0.21 | 0.15 | 0.16 | 0.003 | bal. | 10 | 2.6 | 300 | 1 | 4.3 | 510 | 0.11 | 476 | 548 |
| 4 | 0.20 | 0.21 | 0.40 | 0.15 | 0.003 | bal. | 10 | 2.6 | 300 | 1 | 4.3 | 512 | 0.11 | 476 | 548 |
| 5 | 0.20 | 0.21 | 0.14 | 0.40 | 0.002 | bal. | 10 | 2.6 | 350 | 2 | 4.3 | 511 | 0.11 | 476 | 548 |
| 6 | 0.20 | 0.20 | 0.15 | 0.15 | 0.003 | bal. | 5 | 5.4 | 350 | 1 | 0.8 | 510 | 0.11 | 476 | 548 |
| 7 | 0.21 | 0.20 | 0.15 | 0.14 | 0.002 | bal. | 5 | 2.6 | 350 | 1 | 4.3 | 458 | 0.11 | 476 | 548 |
| 8 | 0.20 | 0.21 | 0.15 | 0.15 | 0.003 | bal. | 5 | 2.6 | 350 | 1 | 4.3 | 560 | 0.11 | 476 | 548 |
| 9 | 0.20 | 0.21 | 0.15 | 0.15 | 0.030 | bal. | 10 | 2.6 | 350 | 1 | 4.3 | 508 | 0.11 | 476 | 548 |
| 10 | 0.21 | 0.20 | 0.15 | 0.15 | 0.003 | bal. | 70 | 2.6 | 350 | 1 | 4.3 | 512 | 0.11 | 476 | 548 |
| 11 | 0.20 | 0.20 | 0.14 | 0.16 | 0.003 | bal. | 10 | 0.8 | 400 | 2 | 5.4 | 510 | 0.11 | 476 | 548 |
| 12 | 0.21 | 0.20 | 0.15 | 0.15 | 0.003 | bal. | 0.1 | 2.6 | 350 | 2 | Wire breakage | | | | |
| 13 | 0.21 | 0.19 | 0.15 | 0.16 | 0.005 | bal. | 10 | 6.2 | Wire breakage | | | | | | |
| 14 | 0.20 | 0.20 | 0.14 | 0.15 | 0.003 | bal. | 10 | 2.6 | 250 | 1 | Wire breakage | | | | |
| 15 | 0.20 | 0.21 | 0.15 | 0.15 | 0.003 | bal. | 10 | 2.6 | 550 | 1 | Wire breakage | | | | |
| 16 | 1.40 | 0.20 | 0.15 | 0.15 | 0.003 | bal. | 10 | 2.6 | 350 | 1 | 4.3 | 509 | 0.11 | 476 | 548 |
| 17 | 0.60 | 0.13 | 0.35 | 0.15 | 0.003 | bal. | 10 | 2.6 | 350 | 1 | 4.3 | 508 | 0.11 | 476 | 548 |
| 18 | 0.90 | 0.42 | 0.20 | 0.15 | 0.003 | bal. | 10 | 2.6 | 350 | 1 | 4.3 | 510 | 0.11 | 476 | 548 |

| | | | | | | | |
|---|---|---|---|---|---|---|---|
| 19 | 0.21 | 0.43 | 0.12 | — | — | bal. | Prepared by other production method *1 |
| 20 | 1.20 | — | 0.23 | 0.03 | — | bal. | Prepared by other production method *2 |
| 21 | 0.10 | — | 0.50 | 0.30 | — | bal. | Prepared by other production method *3 |

| | | | | | | (e) | | | | |
|---|---|---|---|---|---|---|---|---|---|---|
| | | | | | | The number | | | | |
| | | (b) | | | | of repeating | (f) | (f) | | |
| | (a) | Particle | (c) | (c) | (d) | times at | Working | TS change | (g) RA value | |
| | GS | density | TS | EI | EC | breakage | ratio | rate | at 20° C. | at 200° C. |
| No. | (μm) | (/μm²) | (MPa) | (%) | (% IACS) | ×10⁴ | (%) | (%) | (%) | (%) |
| 1 | 17.3 | 26 | 108 | 26.3 | 60.6 | 4.8 | 40 | −7.9 | 63 | 63 |
| 2 | 12.6 | 43 | 142 | 15.0 | 56.8 | 7.2 | 30 | −5.8 | 64 | 60 |
| 3 | 22.2 | 30 | 110 | 24.0 | 60.7 | 5.3 | 30 | −8.8 | 62 | 62 |
| 4 | 13.3 | 34 | 128 | 16.3 | 57.5 | 6.4 | 30 | −5.5 | 63 | 65 |
| 5 | 13.1 | 37 | 127 | 16.5 | 56.6 | 3.8 | 40 | −5.6 | 48 | 51 |
| 6 | 37.2 | 30 | 57 | 3.6 | 59.1 | 3.1 | 20 | −6.6 | 34 | 37 |
| 7 | Unrecrystallized | 35 | 181 | 3.2 | 59.6 | 12.6 | 20 | −10.3 | 36 | 33 |
| 8 | 28.9 | 31 | 72 | 5.4 | 59.5 | 3.3 | 20 | −9.4 | 36 | 39 |
| 9 | 2.1 | 28 | 120 | 19.3 | 52.6 | 4.9 | 30 | −7.4 | 51 | 50 |
| 10 | 11.5 | 32 | 110 | 20.0 | 55.6 | 7.0 | 40 | −7.4 | 67 | 68 |
| 11 | 12.2 | 31 | 131 | 6.8 | 59.3 | 6.7 | 30 | −5.3 | 37 | 39 |
| 12 | Wire breakage | | | | | | | | | |
| 13 | Wire breakage | | | | | | | | | |
| 14 | Wire breakage | | | | | | | | | |
| 15 | Wire breakage | | | | | | | | | |
| 16 | 1.8 | 120 | 145 | 17.6 | 57.1 | 5.6 | 30 | −7.2 | 45 | 35 |
| 17 | 4.3 | 71 | 143 | 13.6 | 53.8 | 7.1 | 20 | −6.8 | 52 | 52 |
| 18 | 4.7 | 107 | 146 | 13.4 | 53.9 | 7.3 | 20 | −6.5 | 53 | 58 |
| 19 | 12 | 105 | 132 | 20.3 | 58.6 | 7.8 | 20 | −5.8 | 82 | 84 |
| 20 | Unrecrystallized | 154 | 270 | 1.0 | 58.2 | 22.9 | 20 | −7.9 | 85 | 86 |
| 21 | Unrecrystallized | 8 | 248 | 5.8 | 54.6 | 13.6 | 20 | 0.8 | 82 | 86 |

Note:
*1 The wire was prepared according to the method reproducing Example 2 in JP-A-2006-253109. The details can be seen in this specification.
*2 The wire was prepared according to the method reproducing Example 6 in JP-A-2006-19163. The details can be seen in this specification.
*3 The wire was prepared according to the method reproducing Example 3 in JP-A-2008-112620. The details can be seen in this specification.

First, from the results in Comparative examples, in regard to Comparative examples 1 to 15 which are comparative examples to the first embodiment, the followings can be understood. Comparative examples 1 to 5, and 9, in which the alloy compositions each were outside of the range as defined in the present invention, each failed to maintain (e) the number of repeating times at breakage and (f) the tensile strength change rate at sufficient levels (the results in Comparative example 9 show that (d) the electrical conductivity was also too low). In Comparative examples 6 to 8, the compositions of the alloys were within the range as defined in the present invention but (a) the grain size was outside of the range as defined in the present invention, and results at satisfactory levels were not obtained in terms of any one or all of (c) the tensile strength, (c) the tensile elongation at breakage, (e) the number of repeating times at breakage, and (f) the tensile strength change rate. Comparative examples 10 to 15 failed to satisfy the target characteristics of alloy (the properties as described above) or caused wire breakage in any of the production steps, due to the production conditions. From Comparative examples 16 to 18, which are comparative examples to the second embodiment, the followings can be understood. When the alloy compositions were outside of the range as defined in the present invention, practically sufficient ones were not obtained in terms of (e) the number of repeating times at breakage and (f) the tensile strength change rate, or other items. Comparative example 19 was a reproduction of Example 2 of JP-A-2006-253109, but the particle density was outside of the range as defined in the present invention, and (e) the number of repeating times at breakage and (f) the tensile strength change rate were not maintained at sufficient levels. Comparative example No. 20 was a reproduction of Example 6 of JP-A-2006-19163, but the grain size and the particle density were, respectively, outside of the ranges as defined in the present invention, and (c) the tensile elongation at breakage and (f) the tensile strength change rate were not maintained at sufficient levels. Comparative example No. 21 was a reproduction of Example 3 of JP-A-2008-112620, but the grain size was outside of the range as defined in the present invention, and (c) the tensile elongation at breakage and (d) the electrical conductivity were not maintained at sufficient levels.

Contrary to the above, the alloy conductors (Examples 1 to 20) according to the first embodiment or the second embodiment of the present invention, each of which had the grain size and the dispersion density of the second phase, respectively in the specific range, exhibited excellent resistance to bending fatigue and excellent resistance to stress relaxation, and was excellent in the workability, and had sufficient mechanical strength, flexibility, and electrical conductivity. From those results, it is understood that the alloy conductor of the present invention can be preferably used as a wiring for a battery cable, a wire harness or a motor each in movable bodies or the like, or as a terminal material thereof.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority under 35 U.S.C. §119 (a) on Patent Application No. 2010-163415 filed in Japan on Jul. 20, 2010, which is entirely herein incorporated by reference.

### REFERENCE SIGNS LIST

1 Test piece (wire)
2, 3 Bending jig
4 Weight
5 Holding jig

1. An aluminum alloy conductor, consisting of: 0.01 to 0.4 mass % of Fe, 0.1 to 0.5 mass % of Cu, 0.04 to 0.3 mass % of Mg, 0.02 to 0.3 mass % of Si, and 0.001 to 0.01 mass % in total of Ti and V, with the balance being Al and inevitable impurities,
wherein, on a cross-section vertical to a wire-drawing direction, a grain size is 1 to 20 μm, and a distribution density of a second phase with a size of 10 to 200 nm is 1 to 10² particles/μm².

2. The aluminum alloy conductor according to claim 1, wherein a cooling speed in a casting step for the aluminum alloy conductor is 1 to 20° C./second, and wherein, on the cross-section vertical to the wire-drawing direction, the grain size is 1 to 5 μm.

3. The aluminum alloy conductor according to claim 1, which has a tensile strength of 100 MPa or more, an electrical conductivity of 55% IACS or more, and a tensile elongation at breakage of 10% or more.

4. A method of producing the aluminum alloy conductor according to claim 1, comprising the steps of: [1] melting, [2] casting, [3] hot- or cold-working, [4] first wire-drawing at a working degree of 1 to 6, [5] intermediate annealing under heat treatment conditions of a temperature of 300° C. to 450° C. and a time period of 10 minutes to 6 hours, [6] second wire-drawing at a working degree of 1 to 6, and [7] finish annealing by a continuous electric heat treatment under conditions satisfying the relationships:
0.03≦x≦0.55, and
26x^{-0.6}+377≦y≦19x^{-0.6}+477
in which y (° C.) represents a wire temperature and x (sec) represents an annealing time period.

5. The method of producing the aluminum alloy conductor according to claim 4, wherein a rod before the first wire-drawing step [4] is heat-treated under heat treatment conditions of a temperature of 300° C. to 450° C. and a time period of 10 minutes to 6 hours.

6. An electrical wiring, comprising the aluminum alloy conductor according to claim 1.

7. A conductor wire for a battery cable, a wire harness, or a motor, each in a movable body, comprising the aluminum alloy conductor according to claim 1.

8. A terminal, comprising the aluminum alloy conductor according to claim 1.

9. An aluminum alloy conductor, consisting of: 0.4 to 1.2 mass % of Fe, 0.02 to 0.5 mass % in total of at least one additive element selected from the group consisting of Cu, Mg, and Si, and 0.001 to 0.01 mass % in total of Ti and V, with the balance being Al and inevitable impurities,
wherein, on a cross-section vertical to a wire-drawing direction, a grain size is 1 to 20 μm, and a distribution density of a second phase with a size of 10 to 200 nm is 1 to 10² particles/μm².

10. The aluminum alloy conductor according to claim 9, wherein a cooling speed in a casting step for the aluminum alloy conductor is 1 to 20° C./second, and wherein, on the cross-section vertical to the wire-drawing direction, the grain size is 1 to 5 μM.

11. The aluminum alloy conductor according to claim 9, which has a tensile strength of 100 MPa or more, an electrical conductivity of 55% IACS or more, and a tensile elongation at breakage of 10% or more.

12. A method of producing the aluminum alloy conductor according to claim 9, comprising the steps of: [1] melting, [2] casting, [3] hot- or cold-working, [4] first wire-drawing at a working degree of 1 to 6, [5] intermediate annealing under heat treatment conditions of a temperature of 300° C. to 450° C. and a time period of 10 minutes to 6 hours, [6] second wire-drawing at a working degree of 1 to 6, and [7] finish annealing by a continuous electric heat treatment under conditions satisfying the relationships:
0.03≦x≦0.55, and
26x^{-0.6}+377≦y≦19x^{-0.6}+477
in which y (° C.) represents a wire temperature and x (sec) represents an annealing time period.

13. The method of producing the aluminum alloy conductor according to claim 12, wherein a rod before the first wire-drawing step [4] is heat-treated under heat treatment conditions of a temperature of 300° C. to 450° C. and a time period of 10 minutes to 6 hours.

14. An electrical wiring, comprising the aluminum alloy conductor according to claim 9.

15. A conductor wire for a battery cable, a wire harness, or a motor, each in a movable body, comprising the aluminum alloy conductor according to claim 9.

16. A terminal, comprising the aluminum alloy conductor according to claim 9.
